(19) United States
(12) Patent Application Publication
(10) Pub. No.: US 2004/0255800 A1
(43) Pub. Date: Dec. 23, 2004

(54) Method and unit for handling and processing blanks for packing tobacco articles

(75) Inventors: Fiorenzo Draghetti, Bologna (IT); Marco Ghini, Monte San Pietro (IT)

Correspondence Address: Ladas & Parry, 26 West 61 Street, New York, NY, 10023, US

(73) Assignee: G.D SOCIETA' PER AZIONI

(21) Appl. No.: 10/782,744

(22) Filed: Feb. 19, 2004

(30) Foreign Application Priority Data
Feb. 20, 2003 (IT) BO2003A000077

(51) Int. Cl. B41F 17/00

(52) U.S. Cl. 101/35

(57) ABSTRACT

A method and unit for handling and processing blanks for packing tobacco articles, wherein the blanks, arranged in groups located in a storage area in a given original arrangement, are removed in groups from the storage area and fed along a path extending through a work station where each blank is subjected to at least one processing operation; the blanks are again formed into groups, and are removed in groups from the path, downstream from the work station, to be fed back to the storage area, and to be formed, in the storage area, into a given arrangement normally similar to the original arrangement; the groups are arranged, in the given arrangement, on pallets located in the storage area, which comprises an unloading area located at an input end of the path, and a loading area located at an output end of the path; a first pallet, loaded with groups of blanks for processing, is moved into the unloading area to feed the groups along the path, and an initially empty second pallet is moved into the loading area to receive the groups of processed blanks.

The present invention relates to a method and unit for handling and processing blanks for packing tobacco articles.

### BACKGROUND OF THE INVENTION

In the tobacco industry, a succession of soft or semirigid blanks is used to form a succession of packages comprising, for example, soft or rigid cigarette packets, cigarette cartons, carton boxes, etc. Such packages are normally produced on high-output systems normally catering to different markets, and which must therefore meet the specific graphic requirements of each market. For example, the blanks normally used for producing packets of cigarettes have a standard basic graphic portion, and a special portion—graphic or otherwise—which differs from one blank to another and/or from one country to another, and which normally comprises special graphics and/or wording in the relative language and/or additional printed or glued-on elements bearing additional information. Alternatively or combined with the above, the special portion may also comprise additional elements, such as hot-glue spots applied to specific points on the blank for future use.

As a result, manufacturers are forced to stock large amounts of different blanks for the same product, thus creating obvious production, storage, and handling problems, and, in many cases, even waste.

One solution devised to at least partly eliminate the above drawbacks, at least as regards the wording and graphics, is to provide, upstream from the packing machine, an on-line printing unit, which receives a succession of stacks of blanks, extracts individual blanks from each stack, feeds a succession of individual blanks through a printing and drying unit, reconstructs the original stacks, and feeds the stacks to the packing machine.

Besides failing to solve graphic problems, such as applying a bar code and/or particular graphics or wording to each blank, on-line printing units of the above type also pose various economic and functional problems. That is, known printing units of the above type require that each production line be equipped with a respective printing unit, which, being located in series with the packing machine, may negatively affect operation and/or output of the machine, and also involves considerable extra cost. Moreover, if sophisticated enough to perform a large number of printing operations and/or operations other than and/or in addition to printing, the cost of on-line printing units of this type would be prohibitive.

WO9110595A1 discloses a cigarette packing machine capable of receiving and folding packaging material and provided with a printing unit capable of printing on the packaging material whilst the material is in transit of the packing machine packing line; a quick-drying ink or UV-responsive ink is utilised to allow for subsequent folding or other working of the packaging material without detriment to the new print. The invention provides for the printing at a late stage of information which is highly time variable, such as price markings, tar and nicotine deliveries, etc; thus the need for large stores of pre-printed material and wastage thereof is eliminated.

### SUMMARY OF THE INVENTION

It is an object of the present invention to provide a method of handling and processing blanks for packing tobacco articles, designed to eliminate the aforementioned drawbacks.

According to the present invention, there is provided a method of handling and processing blanks for packing tobacco articles, wherein the blanks, arranged in groups located in a storage area in a given arrangement, are removed in groups from the storage area and fed along a path extending through at least one work station, where each said blank is subjected to at least one processing operation, and are removed in groups from said path, downstream from said work station, to be fed to said storage area and to be formed, in said storage area, into a given arrangement; the method being characterized in that said groups are arranged, in said given arrangement, on pallets located in said storage area, which comprises an unloading area located at an input end of said path, and a loading area located at an output end of said path; a first pallet, loaded with groups of blanks for processing, being moved into said unloading area to feed the groups along said path; and an initially empty second pallet being moved into said loading area to receive the groups of processed blanks.

The present invention also relates to a unit for handling and processing blanks for packing tobacco articles.

According to the present invention, there is provided a unit for handling and processing blanks for packing tobacco articles, the unit comprising a line for feeding blanks along a given path; at least one work station located along said path and for subjecting each said blank to at least one processing operation; first pickup means for removing groups of blanks, arranged in groups in a given arrangement in a storage area, from the storage area, and feeding them onto said line upstream from said work station; and second pickup means for removing said blanks in groups from said path downstream from said work station, and feeding them, formed into a given arrangement, to said storage area; the unit being characterized in comprising a number of pallets supporting said blanks in said storage area, which comprises an unloading area, which is engaged by said first pickup means, is located at an input end of said path, and receives an initially loaded first said pallet; and a loading area, which is engaged by said second pickup means, is located at an output end of said path, and receives an initially empty second said pallet.

### BRIEF DESCRIPTION OF THE DRAWINGS

A number of non-limiting embodiments of the present invention will be described by way of example with reference to the accompanying drawings, in which:

FIG. 1 shows a schematic view in perspective, with parts removed for clarity, of a preferred embodiment of the handling and processing unit according to the present invention;

FIG. 2 shows a schematic rear side view of the FIG. 1 unit;

FIG. 3 shows a schematic plan view of the FIG. 1 unit;

FIG. 4 shows a schematic plan view of a variation of the FIG. 1-3 unit.

### DETAILED DESCRIPTION OF THE INVENTION

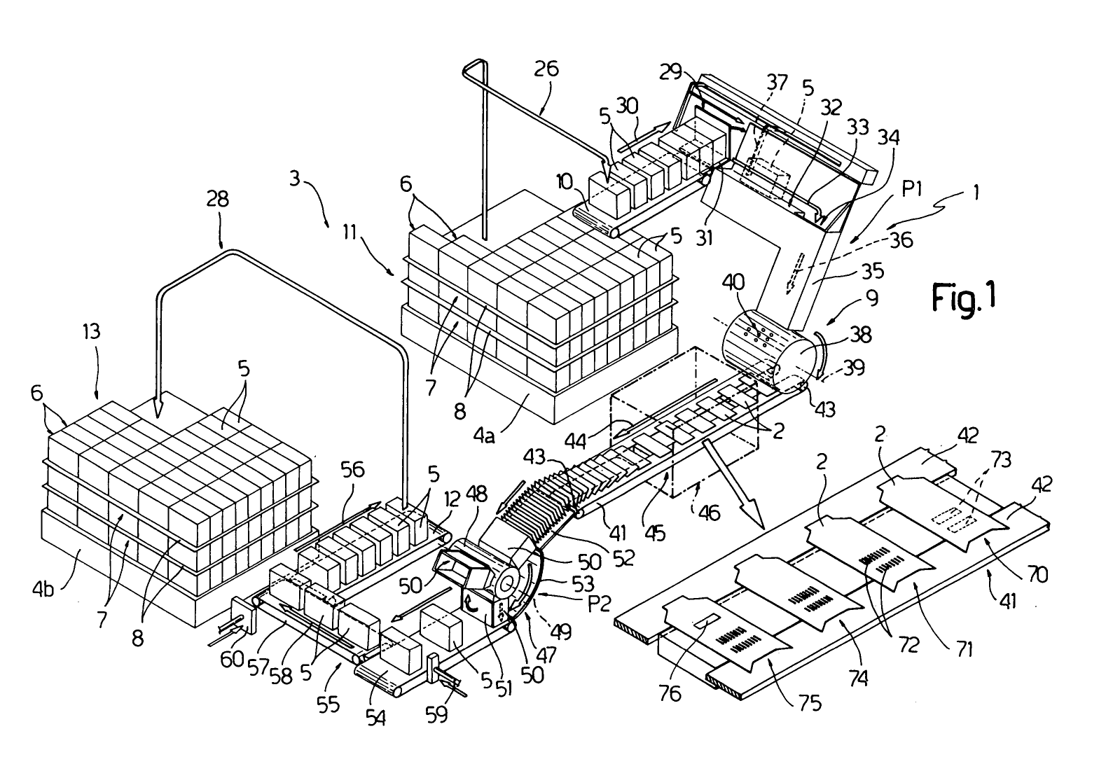

Number 1 in FIG. 1 indicates as a whole a unit for handling and processing blanks 2 for packing tobacco articles (not shown). Unit 1 is located in a storage area 3, where blanks 2 are stored and arranged in given manner on pallets 4. In the example shown in FIG. 1, blanks 2 are arranged in groups, each of which is defined by a stack 5 comprising a number of superimposed blanks 2. Stacks 5 are arranged in side by side rows 6 to form, on each pallet 4, a number of layers 7, each separated from the layer 7 underneath by a separating sheet 8.

Unit 1 comprises a line 9 for feeding blanks 2 along a substantially U-shaped path P1 extending from an input conveyor 10 of line 9—adjacent to an unloading area 11 forming part of storage area 3 and for receiving successive pallets 4a loaded with blanks 2- to an output conveyor 12 of line 9—adjacent to a loading area 13 forming part of storage area 3 and for receiving successive originally empty pallets 4b.

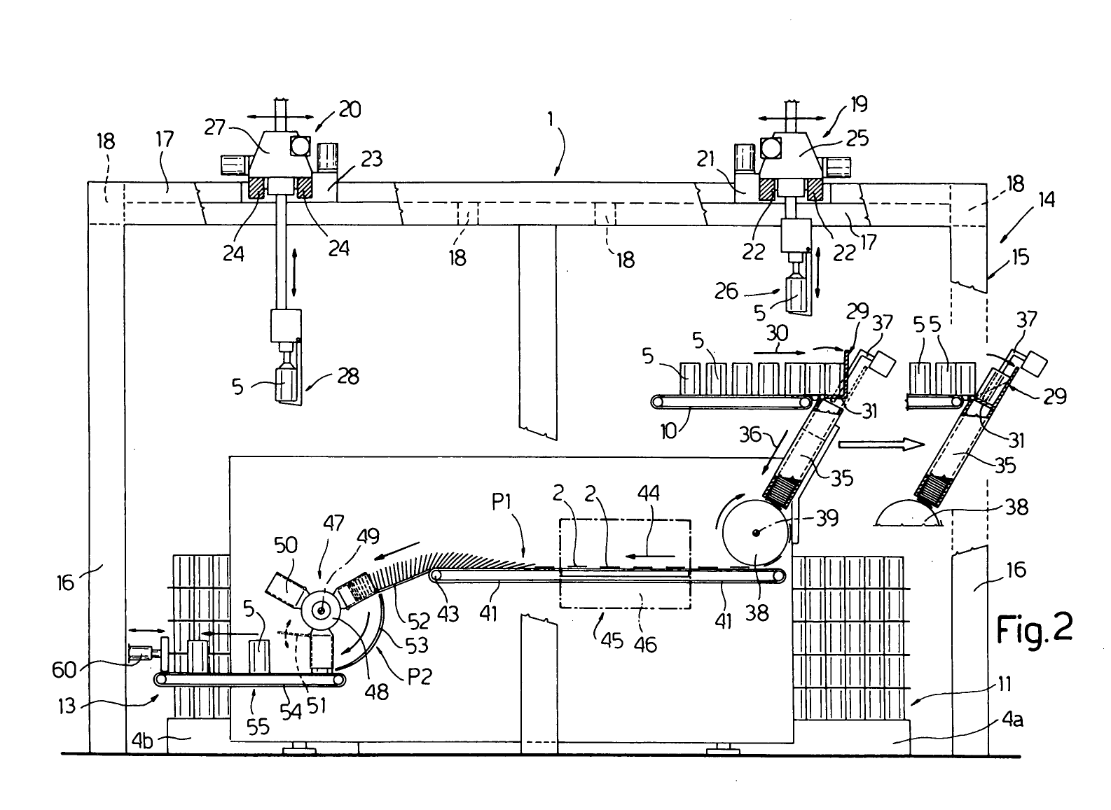

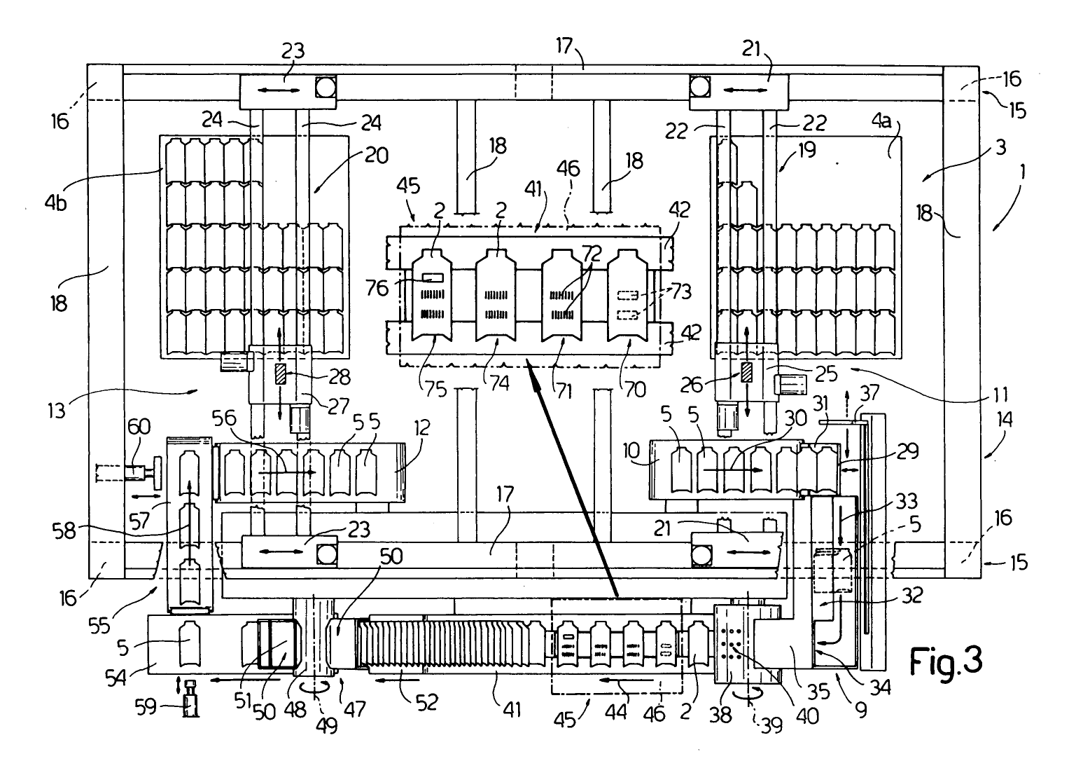

As shown more clearly in FIGS. 2 and 3, unloading and loading areas 11 and 13 are located within a metal structure 14 defined by two parallel vertical gantry structures 15, each comprising two uprights 16 and a cross member 17, and by a number of top cross members 18 connecting the two cross members 17. The two cross members 17 form the rails of two bridge cranes 19 and 20 parallel to top cross members 18; bridge crane 19 is mounted to travel over unloading area 11, and comprises two powered carriages 21 movable along respective cross members 17 and connected to each other by two cross members 22 parallel to top cross members 18; and bridge crane 20 is mounted to travel over loading area 13, and comprises two powered carriages 23 movable along respective cross members 17 and connected to each other by two cross members 24 parallel to top cross members 18. Bridge crane 19 also comprises a powered slide 25 mounted to run along cross members 22, and supporting a known powered pickup device 26 movable, with respect to slide 25, along an axis parallel to uprights 16, and for successively picking up stacks 5 off pallet 4a and depositing them on input conveyor 10. Similarly, bridge crane 20 comprises a powered slide 27 mounted to run along cross members 24, and supporting a known pickup device 28, similar to pickup device 26, which is movable, with respect to slide 27, along an axis parallel to uprights 16, and provides for successively picking up stacks 5 off output conveyor 12 and depositing them on pallet 4b in a given arrangement, normally similar to that of stacks 5 on pallet 4a.

As shown in FIG. 3, input conveyor 10 and output conveyor 12 are located opposite each other, and parallel to each other and to gantry structures 15. As shown more clearly in FIG. 1, in use, input conveyor 10 receives, successively and with a given spacing, the stacks 5 unloaded off pallet 4a by means of a pickup device 26, and feeds them one at a time onto an L-shaped rocking support 29. Support 29 is positioned with its concavity facing the output of input conveyor 10, and rocks, about its end facing input conveyor 10 and about an axis crosswise to the travelling direction 30 of input conveyor 10, between a raised loading position, in which a bottom plate 31 of support 29 is coplanar with input conveyor 10, and a work position, in which bottom plate 31 is tilted and coplanar with a flat track 32 extending, in a direction 33 crosswise to direction 30, between a lateral edge of bottom plate 31 and an inlet 34 of a hopper 35 located on the opposite side of input conveyor 10 to unloading area 11. Hopper 35 has an axis sloping downwards in a direction 36 perpendicular to the plane of track 32 and to direction 33, and successively receives stacks 5 fed by input conveyor 10 onto support 29 and subsequently removed from support 29 and fed along track 32 by a pusher 37. Pusher 37 moves back and forth along track 32 and alternately behind bottom plate 31, when support 29 is in the raised loading position, and over bottom plate 31 and through support 29, when support 29 is in the work position.

Hopper 35 is defined by a tubular body, an open bottom end of which is substantially tangent to the outer surface of a drum 38 rotating, clockwise in FIG. 1, about a respective axis 39 parallel to direction 33, and having at least one suction sector 40 which, as it travels past the open bottom end of hopper 35, removes a blank 2 from hopper 35 and releases it from drum 38 onto the input end of a conveyor 41. Conveyor 41 is defined by two belts 42 looped about two pulleys 43 with respective axes parallel to each other and to axis 39, and feeds a succession of individual blanks 2—equally spaced in series with a given spacing depending on the ratio between the peripheral speed of drum 38 and the linear speed of belts 42, and in a direction 44 opposite direction 30—through a work station 45 where a work unit 46, described in detail later on, subjects each blank 2 to at least one processing, normally a surface processing, operation.

A stacking device 47 is located downstream from conveyor 41, and is defined by a drum 48 rotating in steps, clockwise in FIG. 1, about an axis 49 parallel to axis 39, and having a number of tubular radial hoppers 50 (in the example shown, three hoppers 50 spaced 120° apart about axis 49), each of which is closed at the inner end connected to drum 48, and open at the outer end. Each hopper 50 has a cross section approximately the same shape as, but no smaller, than a blank 2, and has a lateral wall, at the front in the rotation direction of drum 48, defined by a hatch 51 movable between a closed position and an open position respectively closing and opening the side of relative hopper 50. In addition to drum 48, stacking device 47 also comprises a brake device defined by a fixed plate 52, which slopes downwards between the output end of conveyor 41 and drum 48, and has an output end substantially tangent with a circular path P2 travelled by the open ends of hoppers 50 as they rotate about axis 49.

At the end of each step of drum 48, one of hoppers 50 is positioned with its closed hatch 51 coplanar with plate 52, and is moved, in the course of the next step, with its open end substantially contacting the inner surface of a fixed plate 53 shaped like a portion of a cylinder, integral with the output end of plate 52, and extending downwards about axis 49 along a given arc (in the example shown, an arc of about 120°). At the end of this step, the hopper 50 considered is arrested with its open end facing downwards and substantially contacting the top surface of a belt conveyor 54 parallel to and lower down than conveyor 41.

Conveyor 54 defines the input conveyor of a conveyor unit 55, which also comprises an output conveyor coplanar with and parallel to conveyor 54, located in storage area 3, and defined by output conveyor 12, which feeds a succession of stacks 5 in a direction 56 parallel to and opposite direction 44. Conveyor unit 55 also comprises an intermediate conveyor 57 extending in a direction 58 crosswise to direction 56, and having an input end facing the output end of conveyor 54 and for successively receiving stacks 5 transferred from conveyor 54 to intermediate conveyor 57 by means of a pusher 59 acting in direction 58. Output conveyor 12, in turn, has an input end facing the output end of intermediate conveyor 57 and for successively receiving stacks 5 transferred from intermediate conveyor 57 to output conveyor 12 by means of a pusher 60 acting in direction 56.

The stacks 5 on output conveyor 12 are removed successively by pickup device 28 and loaded onto pallet 4b in loading area 13 of storage area 3.

In actual use, a pallet 4a is first brought into unloading area 11 of storage area 3, within the range of pickup device 26, which transfers stacks 5 successively off pallet 4a onto input conveyor 10. By means of input conveyor 10, rocking support 29, and pusher 37, stacks 5 are fed successively to hopper 35, from which a succession of individual blanks 2 is extracted by drum 38, and is fed onto conveyor 41, and by conveyor 41 through work unit 46, where each blank is subjected to at least one processing operation, as described in detail below.

Sloping plate 52 at the output end of conveyor 41 brakes blanks 2 in direction 44, so that the blanks 2 issuing from work unit 46 overlap. As shown in FIG. 1, in normal operating conditions, a stationary hopper 50 is positioned facing the output end of plate 52, and arrests blanks 2, which, overlapping already, are pushed by the blanks 2 coming up behind on conveyor 41 into an on-edge position, in which they are fed into said hopper 50 to reconstruct another stack 5 inside hopper 50. Once this stack 5 is formed, drum 48 is rotated one step to move an empty hopper up to plate 52, and the hopper 50 containing the newly formed stack 5 up to the input of conveyor 54. At this point, hatch 51 is opened to enable conveyor 54 to remove stack 5, which is fed along conveyor unit 55 into a position, on output conveyor 12, in which it is removed by pickup device 28 and deposited onto pallet 4b, on which stacks 5 are normally arranged in the same way as on pallet 4a when brought into unloading area 11.

As will be clear from the foregoing description, unit 1 provides for forming any number of “special” blanks by modifying respective standard blanks, and with no negative effect on packing machine operating time. Moreover, by simply replacing work unit 46 of unit 1, the blanks, still inside storage area 3, can be variously processed in a way which would be impossible when working with on-line blanks.

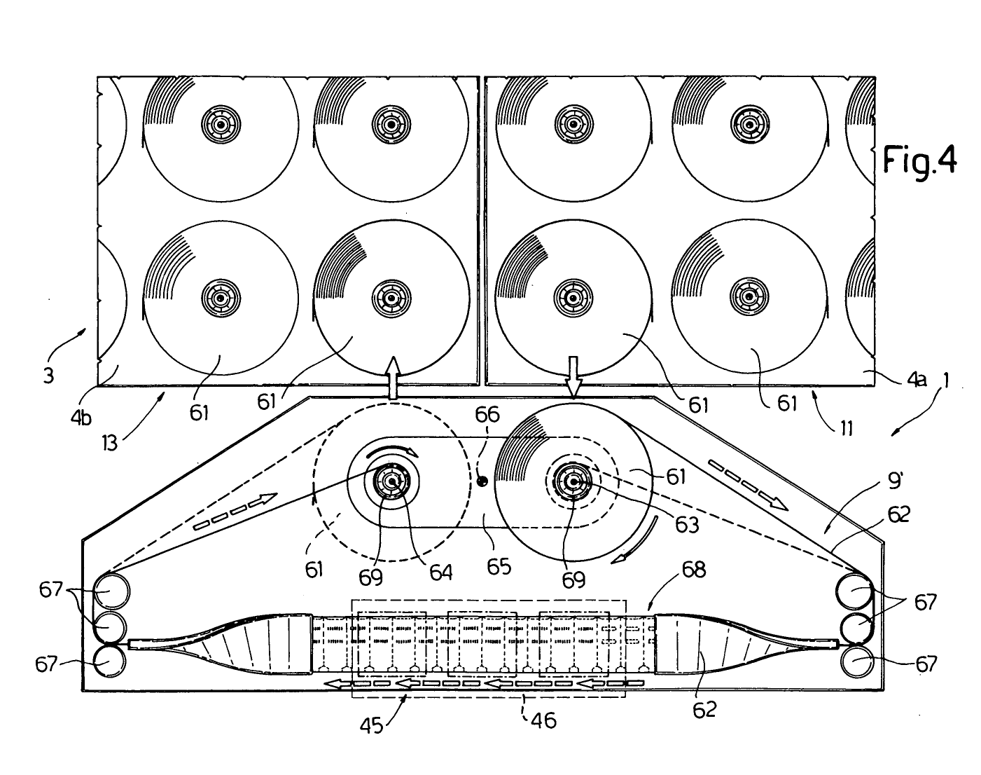

In the FIG. 4 variation, blanks 2 are arranged in groups, each defined by a respective reel 61 of strip 62 defined by a succession of side by side, laterally connected blanks 2.

In the FIG. 4 variation, line 9, indicated 9′, is a substantially U-shaped unwinding line, and comprises an unwinding input pin 63; and a rewinding output pin 64 parallel to unwinding pin 63 and fitted, with unwinding pin 63, to a platform 65, which rotates about an axis 66 parallel to pins 63 and 64 to invert the positions of pins 63 and 64. Line 9′ also comprises a number of guide pulleys 67 for guiding strip 62, unwound off a reel 61 on unwinding pin 63, along a substantially U-shaped path P1 comprising a straight intermediate portion 68 extending through work station 45 and relative work unit 46.

In actual use, a number of reels 61, having respective cores 69, are brought on pallets 4a into unloading area 11, where a known pickup device (not shown), similar to pickup device 26 but modified in known manner to pick up reels, feeds reels 61 successively onto unwinding pin 63. Once a reel 61 is fitted to unwinding pin 63, the relative strip 62 is unwound—preferably by a known automatic unwinding device (not shown) or by hand—along path P1 and connected to an empty core 69 on rewinding pin 64. At this point, rewinding pin 64 is activated to unwind reel 61 on unwinding pin 63, feed the whole of strip 62 through work unit 46, and form a new reel 61 on rewinding pin 64, leaving an empty core 69 on unwinding pin 63. The new reel 61 is removed by a known pickup device (not shown), similar to pickup device 28 but modified in known manner to pick up reels, and is deposited onto a pallet 4b in loading area 13 of storage area 3. Platform 65 is then rotated 180° to invert the functions and positions of the two pins 64 and 65, and the above operations are repeated for a new reel 61.

In the example shown in the accompanying drawings, and particularly in FIG. 1, work unit 46 is a printing unit comprising an input station 70, where each blank 2 is heated in known manner; a station 71—in the example shown, a printing and drying station—where characters or graphics 72 in general are printed and dried in known manner in specific areas 73 on the surface of each blank 2; a station 74—in the example shown, a lacquering and drying station—where the surface printed at station 71 is coated with protective lacquer; and an output station 75 where to the surface of each blank 2 is applied at least one additional element 76, which may be a label and/or a portion of magnetic anti-imitation tape and/or any other means of identifying the relative packet and/or a spot of hot glue.

More specifically, in a variation not shown, work unit 46 may be a gumming unit for applying a number of spots of hot glue to each blank 2.

In a further variation not shown, unit 1 may obviously comprise two or more different work units 46 located in series at respective work stations 45.

1) A method of handling and processing blanks (2) for packing tobacco articles, wherein the blanks (2), arranged in groups (5; 61) located in a storage area (3) in a given arrangement, are removed in groups (5; 61) from the storage area (3) and fed along a path (P1) extending through at least one work station (45), where each said blank (2) is subjected to at least one processing operation, and are removed in groups (5; 61) from said path (P1), downstream from said work station (45), to be fed to said storage area (3) and to be formed, in said storage area (3), into a given arrangement; the method being characterized in that said groups (5; 61) are arranged, in said given arrangement, on pallets (4) located in said storage area (3), which comprises an unloading area (11) located at an input end of said path (P1), and a loading area (13) located at an output end of said path (P1); a first pallet (4a), loaded with groups (5; 61) of blanks (2) for processing, being moved into said unloading area (11) to feed the groups (5; 61) along said path (P1); and an initially empty second pallet (4b) being moved into said loading area (13) to receive the groups (5; 61) of processed blanks (2).

2) A method as claimed in claim 1, wherein the blanks (2) in each said group, as they are fed along said path (P1), are formed into a succession of individual blanks (2) upstream from said work station (45), and are then regrouped, to reconstruct the relative said group (5; 61), downstream from said work station (45).

3) A method as claimed in claim 1, wherein each said group (5; 61) comprises a number of blanks (2) superimposed to form a stack (5), from which the blanks (2) are extracted one at a time, and are arranged in series along said path (P1) to be fed, in a succession of individual blanks (2), through said work station (45).

4) A method as claimed in claim 3, wherein the blanks (2) in said succession of individual blanks (2) are regrouped, downstream from said work station (45), to re-form a succession of said stacks (5).

5) A method as claimed in claim 3, wherein the individual blanks (2) are extracted from each said stack (5) by feeding each said stack (5) into a fixed hopper (35) closed by a movable suction member (38), and by cyclically activating said movable suction member (38).

6) A method as claimed in claim 5, wherein said movable suction member (38) comprises a drum (38) rotating about a respective axis (39) and having at least one suction sector (40).

7) A method as claimed in claim 5, wherein said individual blanks (2) are arranged in series along said path (P1) by moving said movable suction member (38) between positions tangent to said fixed hopper (35) and to a conveyor (41) respectively, and by successively releasing the blanks (2) removed by suction from said fixed hopper (35) onto said conveyor (41).

8) A method as claimed in claim 4, wherein regrouping the blanks (2) downstream from said work station (45) comprises a first braking step, wherein the blanks (2) are overlapped and gradually positioned on edge; a second step of feeding the on-edge said blanks (2) into a container (50) to form a said stack (5) inside the container (50); and a third step of unloading said container (50) onto a conveyor unit (55) for conveying stacks (5).

9) A method as claimed in claim 1, wherein each said group (5; 61) comprises a reel (61) of a strip (62) defined by a number of blanks (2) arranged in series and connected to one another; said reel (61) being unwound along said path (P1) to arrange said blanks (2) in series and feed them successively through said work station (45).

10) A method as claimed in claim 9, wherein said path (P1) extends between an unwinding pin (63) for unwinding a said reel (61), and a rewinding pin (64) for forming a new reel (61).

11) A method as claimed in claim 1, wherein said work station (45) comprises at least one printing station (71) where graphics (72) are printed on each said blank (2).

12) A method as claimed in claim 11, wherein said work station (45) comprises at least one lacquering station (74).

13) A method as claimed in claim 1, wherein said work station (45) comprises at least one station (75) for applying at least one additional identification element to each said blank (2).

14) A method as claimed in claim 1, wherein said work station (45) comprises at least one station (75) for applying at least one spot of hot glue to each said blank (2).

15) A unit for handling and processing blanks (2) for packing tobacco articles, the unit (1) comprising a line (9) for feeding blanks (2) along a given path (P1); at least one work station (45) located along said path (P1) and for subjecting each said blank (2) to at least one processing operation; first pickup means (26) for removing groups (5; 61) of blanks (2), arranged in groups (5; 61) in a given arrangement in a storage area (3), from the storage area (3), and feeding them onto said line (9) upstream from said work station (45); and second pickup means (28) for removing said blanks (2) in groups (5; 61) from said path (P1) downstream from said work station (45), and feeding them, formed into a given arrangement, to said storage area (3); the unit (1) being characterized in comprising a number of pallets (4) supporting said blanks (2) in said storage area (3), which comprises an unloading area (11), which is engaged by said first pickup means (26), is located at an input end of said path (P1), and receives an initially loaded first said pallet (4a); and a loading area (13), which is engaged by said second pickup means (28), is located at an output end of said path (P1), and receives an initially empty second said pallet (4b).

16) A unit as claimed in claim 15, and also comprising ordering means (35, 38; 63) located along said path (P1), upstream from said work station (45), to arrange the blanks (2) in each said group (5; 61) into a succession of individual blanks (2); and regrouping means (47, 52; 64) located along said path (P1), downstream from said work station (45), to re-form said groups (5; 61).

17) A unit as claimed in claim 16, and also comprising a conveyor (41) extending through said work station (45); each said group (5; 61) comprising a number of blanks (2) superimposed to form a stack (5); and said ordering means (35, 38) extracting said blanks (2) one at a time from the relative said stack (5), and depositing the blanks (2) on said conveyor (41) in an orderly succession of individual blanks (2).

18) A unit as claimed in claim 17, wherein said ordering means (35, 38) comprise a fixed hopper (35) having an input (34) for said stacks (5) and a bottom output end; and a suction member (38) movable cyclically past said bottom output end.

19) A unit as claimed in claim 18, wherein said suction member (38) comprises a drum (38) rotating about a respective axis (39) and having at least one suction sector (40).

20) A unit as claimed in claim 18, wherein said drum (38) is tangent to said bottom output end of said fixed hopper (35) and to said conveyor (41).

21) A unit as claimed in claim 16, wherein said regrouping means (47, 52; 64) are stacking means comprising braking means (52) for braking the blanks (2) coming off said conveyor (41), and substantially positioning them on edge; at least one container (50) for receiving the on-edge said blanks (2) and forming, inside it, a stack (5) of said blanks (2); and a conveyor unit (55) for receiving said stacks (5) of blanks (2) from said container (50).

22) A unit as claimed in claim 21, wherein said braking means (52) comprise a fixed plate (52) sloping downwards and located at an output end of said conveyor (41) to receive said succession of individual blanks (2); said container (50) having an open end, and being movable, in a given travelling direction, between a loading position, in which said open end is aligned with said fixed plate (52), and an unloading position, in which said open end faces downwards towards said conveyor unit (55).

23) A unit as claimed in claim 22, wherein said container (50) comprises a lateral wall, at the front in said travelling direction, defined by a hatch (51), which is movable between a normal closed position and an open position respectively closing and opening the side of the container (50).

24) A unit as claimed in claim 21, wherein said regrouping means (47, 50) comprise a drum (48), and a number of said containers (50) projecting radially from said drum (48), which is mounted to rotate in steps about a respective axis (49) to move a said container (50), at each step, from a position aligned with said braking means (52), to a position facing said conveyor unit (55).

25) A unit as claimed in claim 15, wherein each said group (61) comprises a reel (61) of a strip (62) defined by a number of blanks (2) arranged in series and connected to one another; said ordering means (63) and said regrouping means (64) comprising an unwinding pin (63) for unwinding said reel (61), and, respectively, a rewinding pin (64) for receiving said strip (62) and forming the strip (62) into a new reel (61); said path (P1) extending between said two pins (63, 64), and guide means (67) being provided to guide said strip (62) along said path (P1) and through said work station (45).

26) A unit as claimed in claim 15, wherein said work station (45) comprises at least one printing station (71) where graphics (72) are printed on each said blank (2).

27) A unit as claimed in claim 26, wherein said work station (45) comprises at least one lacquering station (74).

28) A unit as claimed in claim 15, wherein said work station (45) comprises at least one station (75) for applying at least one additional identification element to each said blank (2).

29) A unit as claimed in claim 15, wherein said work station (45) comprises at least one station (75) for applying at least one spot of hot glue to each said blank (2).
